(19) United States
(12) Patent Application Publication
(10) Pub. No.: US 2020/0369694 A1
(43) Pub. Date: Nov. 26, 2020

(54) NOVEL CATALYSTS FOR THE SYNTHESIS OF OLIGOMERIC ISOCYANATES

(71) Applicant: Covestro Intellectual Property GmbH & Co. KG, Leverkusen (DE)

(72) Inventors: Frank Richter, Leverkusen (DE); Maximilian Kuner, Berlin (DE); Richard Meisenheimer, Köln (DE)

(21) Appl. No.: 15/930,756

(22) Filed: May 13, 2020

(30) Foreign Application Priority Data
May 24, 2019 (EP) 19176586.6

(51) Int. Cl. C07F 9/6568; C08G 18/02

(52) U.S. Cl. CPC C07F 9/6568; C07F 9/65685; C08G 18/022

(57) ABSTRACT

The present invention relates to innovative catalysts for producing oligomeric polyisocyanates. These catalysts comprise polyhedral silsesquioxanes to which cyclic phosphorus(III) or phosphorus(V) compounds have been coupled.

### CROSS REFERENCE TO RELATED APPLICATIONS

The present application claims priority under the Paris Convention to EP Serial Number EP19176586.6, filed May, 24, 2019, the contents of which are incorporated herein by reference.

### FIELD OF THE INVENTION

The present invention relates to innovative catalysts for producing oligomeric polyisocyanates. These catalysts comprise polyhedral silsesquioxanes to which cyclic phosphorus(III) or phosphorus(V) compounds have been coupled.

### BACKGROUND OF THE INVENTION

Polyhedric silsesquioxanes are known as such, for example from WO 2011/107417.

Phosphines, such as tributylphosphine for example, are used to prepare oligomeric polyisocyanates in the prior art. The use of phospholanes and phobanes for this purpose is also known in principle, for example from EP 2 100 885 A1.

In order to terminate the oligomerization reaction, the prior art describes the inactivation of the catalyst by modification of its chemical structure, for example by oxidation. Depending on the chemical structure of the catalyst, this is not always simple. The catalyst in inactivated form remains part of the product mixture and may have a disadvantageous effect in the case of further processing of the reaction product. In addition, an inactivated catalyst present in the product is not reusable. Depending on the price of the catalyst in question, this can be economically disadvantageous.

For this reason, there exists a need for innovative compounds which catalyze the oligomerization of isocyanates and which can be removed in active form from the reaction product in a simple manner.

### DETAILED DESCRIPTION OF THE INVENTION

This achieved by the embodiments of the present invention disclosed in the patent claims and in the description further below. They may be combined as desired unless the opposite is clear from the context.

In a first embodiment, the present invention relates to a polyhedral compound of the general formula (I)

[(R¹SiO_{3/2})ₙ₋₁(R²SiO_{3/2})]ₙ (I)

in which
n is an even number from 6 to 18, preferably 6 to 12, particularly preferably 6 to 10 and especially preferably 8,
each radical R¹ is each independently
a branched or unbranched C₁₋₂₀-alkyl radical, preferably C₁₋₁₀-alkyl, particularly preferably C₁₋₆-alkyl and especially preferably isobutyl,
a branched or unbranched C₁₋₂₀-alkenyl radical, preferably C₁₋₁₀-alkenyl, particularly preferably C₁₋₆-alkenyl,
a branched or unbranched C₁₋₂₀-alkynyl radical, preferably C₁₋₁₀-alkynyl, particularly preferably C₁₋₆-alkynyl,
a C₄₋₁₂-cycloalkyl radical, preferably C₄₋₈-cycloalkyl, particularly preferably C₄₋₆-cycloalkyl,
a C₁₋₂₀-oxoalkyl radical,
a C₆₋₁₈-aryl radical, preferably C₆₋₁₂-aryl, particularly preferably C₆₋₁₀-aryl, in each case optionally substituted by a heteroatom,
an oxoaryl radical,
a hetaryl radical,
a perfluoro-alkyl, -alkenyl, -alkynyl or -aryl radical,
or
an arylalkylene radical, and

R² is a structural element of the formula (II)

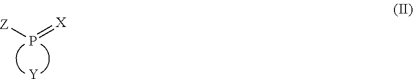

in which

Z is selected from the group consisting of (CR³₂)ₘ, ortho-, meta- or para-C6R³4, C₆R³₄CR³₂, (CR³₂)₂—Si(R³₂)—(CR³₂)ₒ, C₄₋₁₂-cycloalkylene,

and wherein m is a natural number from 1 to 15, preferably 1 to 10, more preferably from 2 to 5, particularly preferably 3 or 4,
o is a natural number from 1 to 4,
R³ are the same or different substituents selected from the group consisting of H, methyl and ethyl, preferably H;

X is a free electron pair or an O atom;

Y is C₄₋₂₀-alkylene, preferably C₄₋₁₆-alkylene, particularly preferably C₄₋₁₀-alkylene, or Y is a polycyclic C₆₋₃₀-alkylene, preferably bicyclic C₆₋₁₀-alkylene.

In this case, the substitution of one or more carbon atoms by an oxygen or sulfur atom is optional, wherein the oxygen or sulfur atom is not directly bonded to the phosphorus atom. Furthermore, Y may comprise one or more double bonds between two carbon atoms of the C₄₋₂₀-alkylene radical, preferably of the C₄₋₁₆-alkylene radical and particularly preferably of the C₄₋₁₀-alkylene radical. The polycyclic C₆₋₃₀-alkylene radical, preferably the bicyclic C₆₋₁₀-alkylene radical, may also comprise one or more double bonds. Furthermore, Y may be branched and/or substituted, in this case the same or different radicals are preferably selected from the group consisting of H, methyl and ethyl.

In the structural elements of the formula (II), Z is a divalent radical which bonds a silicon atom of the polyhedral compound of the general formula (I) to the phosphorus atom of the formula (II).

In particularly preferred embodiments of the invention, Y is C₄-alkylene or bicyclic C₈-alkylene.

Polyhedral compounds of the general formula (I) are also known under the name silsesquioxanes having cage structures. These may have a number of corners from n=6 to n=18 corners. Especially preferred is the cubic structure where n=8.

Polyhedral compounds of the general formula (I) may comprise for R¹ in each case different substituents R¹ as defined above; preferably R¹ is identical. In a preferred embodiment, R¹ in formula (I) is isobutyl.

Preferred structural elements of the formula (II), in which X is a free electron pair, are selected from the group consisting of 1-methylene-1 -phospholane, 1-ethylene-1-phospholane, 1-propylene-1-phospholane, 1 -butylene-1 -phospholane, 1-pentylene-1 -phospholane, 1-hexylene-1-phospholane, 1 -octylene-1-phospholane, 1-phenylene-1-phospholane, 9-methylene-9-phosphabicyclononane, 9-ethylene-9-phosphabicyclononane, 9-propylene-9-phosphabicyclononane, 9-butylene-9-phosphabicyclononane, 9-pentylene-9-phosphabicyclononane, 9-hexylene-9-phosphabicyclononane, 9-octylene-9-phosphabicyclononane, 9-dodecylene-9-phosphabicyclononane, 9-eicosylene-9-phosphabicyclononane and 9-phenylene-9-phosphabicyclononane.

Preferred structural elements of the formula (II) in which X is an oxygen atom are selected from the group consisting of

1-propylene-1-phospholane oxide, 1-butylene-1-phospholane oxide, 1-phenylene-1-phospholane oxide,
9-propylene-9-phosphabicyclononane oxide, 9-butylene-9-phosphabicyclononane oxide, 9-phenylene-9-phosphabicyclononane oxide,
1-propylene-3-methyl-1-phospholane oxide, 1 -butylene-3-methyl-1-phospholane oxide, 1 -phenylene-3-methyl-1-phospholane oxide,
1-propylene-3,4-dimethyl-1-phospholane oxide, 1 -butylene-3,4-dimethyl-1-phospholane oxide, 1 -phenylene-3,4-dimethyl-1-phospholane oxide,
1-propylene-1-phosphol-2-ene oxide, 1-butylene-1-phosphol-2-ene oxide, 1 -phenylene-1 -phosphol-2-ene oxide, 1-propylene-1 -phosphol-3-ene oxide, 1 -butylene-1 -phosphol-3 -ene oxide, 1 -phenylene-1 -phosphol-3-ene oxide,
1-propylene-3-methyl-1 -phosphol-2-ene oxide, 1 -butylene-3-methyl-1 -phosphol-2-ene oxide, 1-phenylene-3-methyl-1-phosphol-2-ene oxide,
1-propylene-3-methyl-1-phosphol-3-ene oxide, 1-butylene-3-methyl-1-phosphol-3-ene oxide, 1-phenylene-3-methyl-1-phosphol-3-ene oxide,
1-propylene-3,4-dimethyl-1 -phosphol-2-ene oxide, 1-butylene-3,4-dimethyl-1-phosphol-2-ene oxide, 1-phenylene-3,4-dimethyl-1-phosphol-2-ene oxide,
1-propylene-3,4-dimethyl-1-phosphol-3-ene oxide, 1-butylene-3,4-dimethyl-1-phosphol-3-ene oxide, 1-phenylene-3,4-dimethyl-1-phosphol-3-ene oxide,
in respect to the substitution on the Y segment, in isomerically pure form or as any mixtures with one another.

In a further embodiment, the present invention relates to the use of the compound according to formula (I) defined above for the oligomerization of isocyanates.

For use in accordance with the invention, the compound according to formula (I) is preferably used such that the proportion thereof, based on the total amount of isocyanates used in moles, is between 5 ppm and 10%.

The term “oligomerization of isocyanates” refers to all processes in which higher molecular weight oligomeric mixtures are formed having uretdione, isocyanurate, carbodiimide and/or iminooxadiazinedione structures in the molecular skeleton. Therefore, the oligo- and polymerization of isocyanates are based in principle on the same chemical reactions. The reaction of a relatively small number of isocyanates with one another is referred to as oligomerization. The reaction of a relatively large number of isocyanates is referred to as polymerization. An oligomerization is present in the context of this application if at least 90 mol% of the reaction products formed are composed of at most 15, preferably at most 10 monomers.

When using catalysts in which X is a free electron pair in formula (II), preferably at least one structure is formed selected from the group consisting of isocyanurate, iminooxadiazinedione, uretdione, and particularly preferably at least one isocyanurate structure is formed. It is likewise preferable that the compound of the formula (I) in which X is a free electron pair in formula (II) is used in a reaction solution comprising a polar and a non-polar phase.

When using catalysts in which X is oxygen in formula (II), the reaction takes place preferably with formation of a carbodiimide stucture. It is particularly preferable that at least 90% of the total crosslinked structures formed are carbodiimide groups.

In principle, the catalysts according to the invention are suitable for the oligomerization of all known isocyanates, i.e. they can be used for oligomerizing isocyanates having aliphatically, cycloaliphatically, araliphatically and aromatically bonded groups. They are preferably used for the oligomerization of mono- and/or diisocyanates.

In the case of an isocyanate with aliphatically bonded isocyanate groups, all isocyanate groups are bonded to an sp³-hybridized carbon atom. Preferred polyisocyanates with aliphatically bonded isocyanate groups are n-butyl isocyanate and all isomers thereof, n-pentyl isocyanate and all isomers thereof, n-hexyl isocyanate and all isomers thereof, 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane and 1,10-diisocyanatodecane.

In an isocyanate having cycloaliphatically bonded isocyanate groups at least one of the isocyanate groups is bonded to carbon atoms which are part of a closed ring of carbon atoms. This ring may be unsaturated at one or more sites provided that it does not attain aromatic character as a result of the presence of double bonds. Preferred polyisocyanates having cycloaliphatically bonded isocyanate groups are cyclohexyl isocyanate, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato- 1 -methyl-4(3)-isocyanatomethylcyclohexane, 2,4′- and/or 4,4′-diisocyanatodicyclohexylmethane (H12MDI), 1,3- and/or 1,4-bis(isocyanatomethyl)cyclohexane, bis(isocyanatomethyl)norbornane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

In an isocyanate having araliphatically bonded isocyanate groups, all isocyanate groups are bonded to alkylene radicals which are in turn bonded to an aromatic ring. Preferred polyisocyanates having araliphatically bonded isocyanate groups are 1,3- and 1,4-bis(isocyanatomethyl)benzene (xylylene diisocyanate; XDI), 1,3- and 1,4-bis(1-isocyanato-l-methylethyl)benzene (TMXDI) and bis(4-(1-isocyanato-1-methylethyl)phenyl) carbonate.

In an isocyanate having aromatically bonded isocyanate groups all isocyanate groups are bonded directly to carbon atoms which are part of an aromatic ring. Preferred isocyanates having aromatically bonded isocyanate groups are 2,4- and 2,6-diisocyanatotoluene (TDI), 2,4′- and 4,4′-diisocyanatodiphenylmethane (MDI) and 1,5-diisocyanatonaphthalene.

If it is desired to produce oligomeric polyisocyanates which are composed of more than one isocyanate, any desired mixtures of the aforementioned isocyanates may be used for the oligomerization.

The study on which the present invention is based has shown that the catalysts according to the invention are soluble in non-polar solvents in which oligomeric isocyanates are insoluble or only poorly soluble. This enables the removal of the catalyst from the reaction mixture and, if desired, recovery thereof in active form.

Consequently, the present invention in a further embodiment relates to a process for producing a polyisocyanate composition comprising oligomeric polyisocyanates comprising the steps of
a) providing a reaction mixture comprising at least one compound according to the general formula (I) as defined above and at least one isocyanate;
b) reacting the at least one isocyanate to give an oligomeric polyisocyanate;
c) extracting the compound according to formula (I) from the reaction mixture by extraction with a suitable solvent A.

All further definitions stated above for the structure of the catalysts according to the invention and use thereof also apply to this embodiment.

The reaction mixture provided in process step a) comprises at least one isocyanate. However, the reaction mixture, as already outlined above, may also comprise different isocyanates. It comprises at least one compound according to formula (I). The presence of further compounds which catalyze the oligomerization of isocyanates, but which do not fall under formula (I), is possible in principle in accordance with the invention. In order to fully achieve the advantages of the invention, it is preferable that such compounds make up at most 0.5% by weight, more preferably at most 0.1% by weight, of the reaction mixture.

It is preferable that the molar ratio of the compound according to formula (I) and the total amount of all isocyanates in the reaction mixture provided in process step a) is between 5 ppm and 10%, in which the molar amount of the compound according to formula (I) in moles of phosphorus and the molar amount of all isocyanates present in moles of NCO are determined. Suitable analytical methods are known to the person skilled in the art.

The process step of “providing” the reaction mixture results in as homogeneous a mixture as possible of the components present therein. This result can be achieved by all mixing processes familiar to those skilled in the art and suitable for the present components. In this context, it is preferable to dissolve the catalyst in a suitable solvent prior to addition to the isocyanate. These are particularly those solvents which do not comprise any groups reactive to isocyanate groups, and the boiling point of which is above the reaction temperature prevailing in the process step. “Reactive to isocyanate groups” in the context of the present application are especially hydroxyl, amino and thiol groups. Said solvents are further characterized in that oligomeric polyisocyanates are poorly soluble therein. Solvent A is preferably selected such that the oligomers formed in process step b) are soluble therein to a maximum of 10% by weight. Particularly preferred solvents are branched, unbranched and cyclic alkanes having 6 to 20 carbon atoms which are liquid at the reaction temperature.

The “reaction of at least one isocyanate to give an oligomeric polyisocyanate” is carried out by incubating the reaction mixture at a suitable temperature. This temperature can be determined by simple preliminary experiments for the specific combination of isocyanate and catalyst in each case. In principle, suitable temperatures are in the range between 40° C. and 220° C. Depending on the catalyst used, different temperature ranges here are particularly well suited.

When using structural elements according to formula (II), in which Z is a free electron pair, for the oligomerization of aromatic isocyanates, temperatures of at least 20° C. are preferred. If isocyanates having aliphatically bonded isocyanate groups are intended to be oligomerized using these catalysts, minimum temperatures of 40° C. are preferred. In each case, the temperature should not exceed 200° C., preferably 150° C.

When using structural elements according to formula (II), in which Z is oxygen, independently of the isocyanate used, a temperature range of 100° C. to 220° C., especially 140° C. to 200° C., is preferred.

The duration of process step b) is determined by the desired degree of conversion of the isocyanates. This is preferably in the range of 1 hour to 48 hours. The respective NCO content is determined by titrimetric means in accordance with DIN EN ISO 11909:2007-05.

In the subsequent process step c), the compound according to formula (I) is extracted by a suitable solvent A. In particular, all catalyst solvents described above are suitable as a single substance or as a mixture.

Particular preference is given to extraction using optionally branched alkanes. Preference is given to using at least 10% by weight solvent A for the extraction, based on the mass of the reaction mixture. This extraction in process step c) is carried out at least once. Multiple implementation is also possible however and may be preferred.

It is preferred that, at the end of process step c), at least 90 mol % of the compound according to formula (I) present in the reaction mixture at the start of process step c) is dissolved in the solvent A.

In a further embodiment of the present invention, the process according to the invention is carried out biphasically. Added to the reaction mixture defined above is a further solvent B, which is immiscible with the reaction mixture and the solvent A used for the extraction of the compound according to formula (I). Said solvent B can be the product phase formed from the isocyanate to be reacted and is generally selected such that oligomeric isocyanates formed are more soluble therein than in the solvent A, whereas the compound according to formula (I) is considerably more poorly soluble therein. For instance, it can be achieved that during the oligomerization the reaction products pass continuously into a second phase or these form (reacted isocyanate) in which there is little or no catalyst present. Thus, on the one hand the formation of larger oligomers is suppressed and on the other hand a simple separation of the reaction products from the catalyst is enabled.

Particularly preferred is a solvent pair which is characterized by the following parameters:

The solubility of the compound according to formula (I) in solvent A is higher than in solvent B by at least a factor of 10. By way of example, solvent A are alkanes in which the generally available monomeric (di)isocyanates are soluble.

Furthermore, the solubility of the oligomers formed in process step b) in solvent B must be higher than in solvent A by at least a factor of 10 which, in the preferred case, when solvent B is the product phase, is especially possible without any problem.

In addition to the process products, if they are liquid at the planned reaction temperature, aprotic, polar solvents such as acetonitrile as solvent B are very suitable. The latter is particularly suitable for the combination with optionally branched alkanes as solvent A. Further combinations of suitable aprotic solvents with miscibility gaps are known from the relevant specialist literature and tabular works such as the CRC Handbook of Chemistry and Physics (examples of these: diethyl ether (solvent A)/dimethyl sulfoxide (solvent B), alkanes (solvent A)/dimethyl sulfoxide (solvent B), alkanes (solvent A)/dimethylformamide (solvent B), and many more) and may also be determined by simple preliminary tests. For this purpose, the non-polar solvent A is submitted to the temperature to be investigated, in the simplest case at room temperature, and the potentially immiscible polar solvent B is added dropwise with stirring until lack of mixing is observed.

Any desired mixtures can be used as solvent A and/or B in accordance with the invention, provided that the corresponding mixtures have the miscibility properties above. Mixtures of this kind comprise, for example, petroleum ether fractions. In particular, standard paint solvents such as n-butyl acetate, methoxypropyl acetate, xylene and solvent naptha, which do not per se form any miscibility gaps with very non-polar solvents such as alkanes at room temperature, are nevertheless suitable as solvent B if they are used in only low amounts, based on the amount of solvent A, in order to lower the viscosity of the product-carrying catalyst-poor phase. As mentioned above, “low amount” is preferably understood to mean below 30% by weight, more preferably below 20% by weight, even more preferably below 10% by weight and most preferably below 5% by weight.

In yet a further embodiment, the present invention relates to an oligomeric polyisocyanate composition comprising a phosphorus content below 100 ppm by weight, preferably between 0 and 100 ppm by weight, particularly preferably between 0 and 50 ppm by weight and especially preferably between 0 and 20 ppm by weight, based on the total weight of the oligomeric polyisocyanate composition. Expressed differently, the present invention further relates to an oligomeric polyisocyanate composition, obtainable or obtained by the process according to the invention and preferred embodiments thereof. The oligomeric polyisocyanate composition according to the invention enables the combination of the use of phosphorus-containing catalysts while at the same time avoiding the addition of catalyst poisons which remain predominantly in the product.

The phosphorus content in ppm is preferably determined by X-ray fluorescence analysis (XFA).

The NCO content of the oligomeric polyisocyanate composition according to the invention mentioned above is preferably between 5% by weight and 35% by weight, more preferably between 10% by weight and 30% by weight and even more preferably between 15% by weight and 25% by weight. The NCO content is determined by titrimetric means in accordance with DIN EN ISO 11909:2007-05.

Said oligomeric isocyanate composition preferably comprises to an extent of at least 90% by weight, more preferably at least 95% by weight, aliphatic and/or cycloaliphatic and/or aromatic isocyanates, based on the total amount of all isocyanates.

The working examples which follow serve merely to illustrate the invention. They are not in any way intended to limit the scope of protection of the claims.

### EXAMPLES

All examples were carried out to elucidate the effects according to the invention with hexamethylene diisocyanate and oligomers thereof (oligomerization reactions using P(III) compounds) or with bis(4-isocyanatocyclohexyl)methane (carbodiimidizations using P(V) compounds, P-oxides). This is not intended to signify any limitation to the catalysts and isocyanates described in the examples.

All % amounts refer to the mass unless otherwise noted.

Mol % data were determined by ¹ H-NMR spectroscopy and refer to the sum total of isocyanate conversion products, unless stated otherwise. All NMR measurements (¹ H; ¹³C, ²⁹Si, ⁻P) were conducted on the instruments Bruker Avance III HD-600 (600 MHz proton frequency) or DRX 700 (700 MHz proton frequency) on ca. 1-2% solutions in dry C₆D₆, unless stated otherwise. The chemical shift (in ppm) was referenced to the signal of non-deuterated residues in the solvent (C₆D₅H: 7.15 ppm; C₆D₆: 128.7 ppm). ²⁹Si- and ³¹P-NMR spectra are referenced externally to Me₄Si (0 ppm) or 85% H₃PO₄ (0 ppm).

The NCO content was determined by titration in accordance with DIN EN ISO 10283:2007-11.

Size exclusion chromatography was carried out in accordance with DIN 55672-1:2016-03 and tetrahydrofuran as elution solvent. The values obtained by PSS standard calibration were recalibrated for calculating Mn, Mw and D in the case of HDI oligomers (HDI, n=1: 168.2 g/mol, HDI dimer, n=2: 336.4 g/mol; HDI trimers, n=3: 504.6 g/mol; and so on) with the exception area %=mass %.

The phosphorus content of the inventive and the comparative products was determined by X-ray fluorescence analysis (XFA).

The synthesis of the compounds of the formula (I) is carried out by literature methods by standard reactions for the P-C bond linkage (P(III) compounds), optionally followed by an oxidation (P-oxides). Suitable for this purpose are functionalized POSS precursors on the one hand (haloalkyl-POSS and vinyl- or allyl-POSS) and on the other hand secondary phosphanes which can be bonded, for example, by radical addition to the double bond of the vinyl- or allyl-POSS units or by deprotonation by means of halide elimination of the haloalkyl-POSS compounds. All starting materials, if not commercially available (Aldrich, ABCR, Hybrid Catalysis, Solvay (formerly Cytec), DuPont, Covestro Deutschland AG), were synthesized by known literature methods.

One example for the general procedure for the synthesis of the compounds of the formula (I) is listed below; that of a C4-bridged species via the haloalkyl-POSS route in Ex. 1 and that of a C3-bridged species via the allyl-POSS route in Ex. 2. By adding at least stoichiometric amounts of cumyl hydroperoxide to the P(III) compounds A to D, the corresponding P(V) compounds (P-oxides) E and F were obtained in virtually quantitative yield.

The compounds A to F used as catalysts in the working examples according to the invention are listed in Table 1.

TABLE 1

| No. | Structural formula | Trivial name |
|---|---|---|
| A | 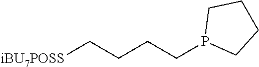 | iBu₇POSS- butylene- phospholane |
| B | 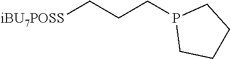 | iBu₇POSS- propylene- phospholane |
| C | 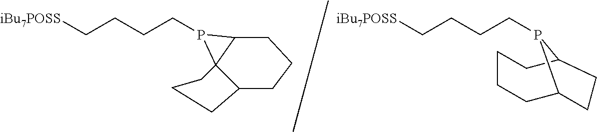 | iBu₇POSS- butylene- phobane, isomeric mixture |
| D | 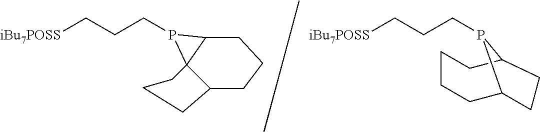 | iBu₇POSS- propylene- phobane, isomeric mixture |
| E | 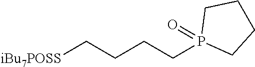 | iBu₇POSS- butylene- phospholane oxide |
| F | 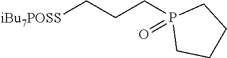 | iBu₇POSS- propylene- phospholane oxide |

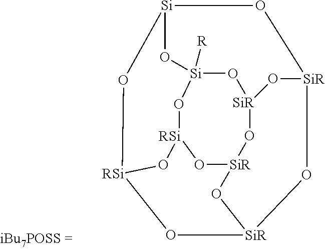

wherein R=iBu and [symbol] bond to the P-substituited alkylene spacer

### Example 1 Catalyst Synthesis, iBu7POSS-Butylene-Phospholane A

In a baked-out Schlenk tube, 0.96 g (10.94 mmol) of phospholane were dissolved under a nitrogen atmosphere in 3 ml of oxygen-free, dry THF and cooled to −78° C. 3.67 g (13.23 mmol) of n-butyllithium were added dropwise as a 2.5 M solution in n-hexane. The reaction mixture was brought to room temperature, stirred for one hour and again cooled to −78° C. An oxygen-free solution of 10.75 g (11.28 mmol) of iBu₇POSS-butylene bromide in 25 ml of THF was then added dropwise to the phosphide solution. After addition was complete, the reaction mixture was stirred at room temperature overnight, then concentrated to ca. 10 ml under reduced pressure and oxygen-free methanol (50 ml) was added with stirring. Filtration and repeated washing of the precipitated precipitate with oxygen-free methanol afforded 8.80 g (9.17 mmol, 83.9% of theory) of catalyst A as a white solid.

¹ H-NMR (600 MHz, C₆D₆): δ(ppm)=2.23;- 2.02; (m, 7H, CH), 1.76;-1.68; (m, 2H, CH2), 1.66;-1.42; (m, 4H, CH₂), 1.34;-1.25; (m, 2H, CH₂), 1.22;-1.14; (m, 2H, CH₂), 1.13;- 1.06; (m, 42H, CH₃), 0.9;0-0.81; (m, 16H, CH2). ¹³C-NMR (151 MHz, C₆D₆): δ(ppm)=30.7, 29.6, 29.5, 28.3, 26.6, 26.5, 26.2, 24.7, 24.7, 23.3, 12.8. ³¹P-NMR (243 MHz, C₆D₆): δ(ppm)=−27.2. ²⁹Si-NMR (119 MHz, C₆D₆): δ(ppm)=−66.7, −67.3, −67.6.

### Example 2 Catalyst Synthesis, iBu₇POSS-Propylene-Phobane (Isomeric Mixture) D

9 g (10.4 mmol) of allyl-heptaisobutyl-POSS were dissolved in degassed toluene (20 ml) under a nitrogen atmosphere in a previously baked-out Schlenk tube, 1.42 g (10 mmol) of phobane (isomeric mixture as 50% solution in toluene) were added and reacted under reflux over a period of 6 hours and with occasional addition collectively of 200 mg of azo initiator VAZO 76 (2,2′-azobis(2-methylbutyronitrile), as a 5% solution in toluene).

After removing all volatile components under reduced pressure (0.1 mbar) at a maximum of 150° C., 8.5 g (8.5 mmol; 85% yield) of catalyst D were obtained as a white powder. The analytical data do not differ from the product obtained according to the method described under Example 1 from 3-chloropropylheptaisobutyloctasilsesquioxane and phobane deprotonated by means of n-butyllithium.

### Example 3 Solubility Tests on HDI Derivatives

In order to test whether isooctane is suitable as non-polar solvent for a biphasic oligomerization, firstly the solubility of HDI on the one hand and of the HDI oligomers with the lowest molecular weight (“ideal structures”, see below) on the other hand, in isooctane were determined. HDI also has no miscibility gap with isooctane at room temperature. The respective “ideal structures”, i.e. the compounds having in each case the minimum possible molecular weight and thus the highest possible potential solubility in non-polar solvents, were isolated from the commercially available HDI polyisocyanates from Covestro Deutschland AG (DESMODUR N 3300, DESMODUR N 3400, DESMODUR N 3900) in accordance with the procedure described in EP 0798299, Ex. 3 and 6 (see also ACS Sustainable Chem. Eng. 2018, 6, 9753-9759) and the solubility thereof in isooctane at 23° C. and at 60° C. were determined. The solubilities of selected HDI oligomers (“ideal structures”) in isooctane^{a)} are shown in Table 2.

| | Solubilityat | Solubility at |
|---|---|---|
| Table 2Oligomer-“ideal structure” | 23° C. [%] | 60° C. [%] |
| Bis(6-isocyanatohexyl)uretdione (“dimer”) | 2.3 | 5.7 |
| Tris(6-isocyanatohexyl)isocyanurate (“trimer”) | 0.7 | 2.0 |
| Tris(6-isocyanatohexyl)iminooxadiazinedione/ | 1.0 | 3.1 |
| isocyanurate ca. 40%/60% mixture | | |
| (“asymmetric/symmetrictrimer”) | | |

a) determined by ¹H-NMR

As a result of this, the solubilities themselves at 60° C. are relatively low which is why isooctane should be well suited for the extraction of a non-polar POSS-bonded catalyst from a product mixture comprising HDI and oligomers therefrom and also for a biphasic reaction regime.

To investigate other monomers and oligomers resulting therefrom, any solvents or solvent combinations can be derived by means of simple analogous preliminary experiments for screening the suitability of the relevant solvents or solvent combinations for the intended purpose.

### Examples 4-7 (Inventive) Monophasically Conducted Oligomerization with Subsequent Extraction of the Catalysts

To investigate the catalytic activity and selectivity of the catalysts A to D, 14.2 g of hexamethylene diisocyanate (product of Covestro Deutschland AG) were added under a nitrogen atmosphere to the respective phosphorus(III) catalyst A to D (0.28 mmol) dissolved in isooctane (1 ml). The solutions were heated to 60° C. and, at regular intervals, the conversion and product selectivity with respect to the isocyanate conversion products formed were investigated by ¹H-NMR. Mn, Mw and D were determined as described at the outset, disregarding the monomer fraction.

It was shown in this case that both turnover frequency (TOF) and selectivity with regard to the structure types formed (isocyanurate, iminooxadiazinedione and uretdione) by the catalysts A to D are very similar to those of the non-POSS-bonded counterparts - as shown in EP 08004769.

The catalysts were recovered by diluting the reaction mixtures with acetonitrile (10 ml) and subsequent extraction with isooctane (3×20 ml) in a separating funnel from the polar, acetonitrile-rich phase. The phosphorus content of the polar acetonitrile-rich phase was below 5 ppm P (below the detection limit)

### Examples 8 and 9 (Inventive) Biphasically Conducted Oligomerization with Subsequent Chemical Deactivation of the Catalyst and Solvent Removal

For the biphasic oligomerizations, catalyst C:

0.41 g (0.45 mmol) example 8
or
3.28 g (3.6 mmol) example 9
was dissolved in isooctane (20 ml) under a nitrogen atmosphere and HDI (13.8 g, 82 mmol) was added.

The homogeneous clear reaction solutions were heated to 60° C. and stirred with the aid of a stirrer at the lowest setting (39 min⁻¹), in order to avoid emulsion formation. In both cases, after some time (example 8: 3 h; example 9: 30 min), phase separation occurred due to separation of the HDI oligomeric mixture formed. The reaction was terminated by adding elemental sulfur (15 mg, example 8, or 120 mg, example 9) and further stirring at 60° C. and higher speed of the stirrer (400 min⁻¹) for one hour. Subsequently, with stepwise reduced pressure at 60° C., all the solvent was removed and the viscous residue remaining was analyzed by ¹ H-NMR spectroscopy and size exclusion chromatography. The results are compiled in Table 3. The result of example 6, which was likewise conducted with catalyst C up to a gross monomer conversion comparable to example 9 (ca. 20% monomer according to size exclusion chromatography), is also listed for comparison.

TABLE 3

| Ex. | Isocyanurates | Iminooxadiazinediones | Oxadiazinetriones | Uretdiones | Mn | Mw | D |
|---|---|---|---|---|---|---|---|
| 8 | 61 mol % | 23 mol % | 2 mol % | 14 mol % | 565 | 616 | 1.1 |
| 9 | 66 mol % | 22 mol % | 1 mol % | 10 mol % | 735 | 851 | 1.2 |
| 6 | 68 mol % | 21 mol % | 1 mol % | 10 mol % | 1092 | 1550 | 1.4 |

As can be seen from the results, a distinctly narrower molecular weight distribution (lower value for the polydispersity D at comparable monomer conversion) is found in the case of heterogeneous reaction regimes, than in the continuously homogeneously catalyzed case. By means of selection of the reaction temperature, the reaction time (and thus the monomer conversion), the catalyst concentration (amount) and the amount of non-polar solvent (initial dilution), the polydispersity of the products obtained can be varied further.

The catalyst was chemically deactivated here only for simplifying the analytical assessment of the inventive effect: narrower molecular weight distribution compared to the homogeneously catalyzed case at comparable monomer conversion, and can be omitted in the case of a continuous reaction regime with continuous separation of the product-rich phase and synchronous addition of fresh monomer.

Optionally desired removal of the unreacted monomer from the polar catalyst-poor or catalyst-free product phase can subsequently be carried out by any method from the prior art, preferably (further) extraction with non-polar solvent and/or distillation. In this case, benefit is derived from the fact that catalyst remains to a large extent in the low oligomer (essentially low fractions of the “ideal structures” as shown in Ex. 3), monomer and non-polar solvent phase, which may all be recycled, and from the almost complete absence of catalyst in the product, which renders the process very lucrative from ecological and economic aspects also.

### Examples 10 and 11 (Inventive) and 12 (Comparative)

To investigate the catalytic activity and selectivity of catalysts E and F and the non-inventive comparative catalyst 1-methylphospholane oxide (MPO), under a nitrogen atmosphere the respective phosphorus(V) catalyst E, F and MPO (in each case 5 mmol ; E and F dissolved in 3 ml of isooctane, MPO without solvent,) and 100 g (0.38 mol) of bis(4-isocyanatocyclohexyl)methane (DESMODUR W; product of Covestro Deutschland AG) were added.

The mixtures were heated to 160° C. and, over the course of 10 h at regular intervals, the conversion monitored by NCO titration, see Table 4.

TABLE 4

| Ex. | Catalyst | Conversion after 10 h |
|---|---|---|
| 10 | E | 35 % |
| 11 | F | 24 % |
| 12 | MPO | 35 % |

The reaction was terminated by cooling, diluted with acetonitrile and then the acetonitrile phase was extracted with isooctane in analogy to the procedure in example 4-7.

The phosphorus content of the polar, acetonitrile-rich phase was below 5 ppm P (below the detection limit) in the inventive examples 10 and 11.

The intensive signal of MPO at ca. 67 ppm in the ³¹P-NMR spectrum of the product from the comparative example 12 confirmed the expected poor extractability of the catalyst in comparative example 12, 567 ppm P were found by X-ray fluorescence spectroscopy.

Various aspects of the subject matter described herein are set out in the following paragraphs:

A compound of the general formula (I), [(R¹SiO_{3/2})]ₙ₋₁(R²SiO_{3/2})ₙ (I), in which n is an even number from 6 to 18, each radical R¹ is each independently a branched or unbranched C₁₋₂₀-alkyl radical, a branched or unbranched C₁₋₂₀-alkenyl radical, a branched or unbranched C₁₋₂₀-alkynyl radical, a C₄₋₁₂-cycloalkyl radical, a C₁₋₂₀-oxoalkyl radical, a C₆₋₁₈-aryl radical, an oxoaryl radical, a hetaryl radical, a perfluoro-alkyl, -alkenyl, -alkynyl, -alkoxyalkyl- or -aryl radical, or an arylalkyl radical, and R² is a structural element of the formula (II)

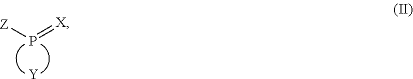

in which Z is selected from the group consisting of (CR³₂)ₘ, ortho-, meta- or para-C₆R³₄, C₆R³₄CR³₂, (CR³₂)-Si(R³₂)-(CR³₂)ₒ, C₄₋₁₂-cycloalkylene, and wherein m is a natural number from 1 to 15, o is a natural number from 1 to 4, R³ are the same or different substituents selected from the group consisting of H, methyl and ethyl, Y is C₄₋₂₀-alkylene or polycyclic C₆₋₃₀-alkylene and X is a free electron pair or an O atom.

The compound according to the previous paragraph, wherein m is an even number from 6 to 12, preferably from 6 to 10, particularly preferably 8, each radical R¹ is each independently a branched or unbranched C₁₋₁₀-alkyl radical, preferably C₁₋₆-alkyl and particularly preferably isobutyl, a branched or unbranched C₁₋₁₀-alkenyl, preferably C₁₋₆-alkenyl, a branched or unbranched C₁₋₁₀-alkynyl, preferably C₁₋₆-alkynyl, a C₄₋₈-cycloalkyl, preferably C₄₋₆-cycloalkyl, a C₆₋₁₂-aryl, preferably C₆₋₁₀-aryl, in each case optionally substituted by a heteroatom, Z is selected from the group consisting of (CR³₂)ₘ, ortho-, meta- or para-C₆R³₄, C₆R³₄CR³₂, C₄₋₁₂-cycloalkylene, m is a natural number from 1 to 10, preferably from 2 to 5, particularly preferably 3 or 4, R³ is H, X is a free electron pair or an O atom and Y is C₄₋₁₆-alkylene, preferably C₄₋₁₀-alkylene, particularly preferably C₄₋₈-alkylene or Y is a bicyclic C₆₋₁₀-alkylene.

The compound according to one of the previous paragraphs, wherein n=8, R¹ is C₄-alkyl, Z is (CR³₂)ₘ where m=3 or m=4 and R³=hydrogen, Y is C₄-alkylene or C₈-bicycloalkylene, and X is a free electron pair or an O atom.

Use of a compound as defined in any of the previous paragraphs for the oligomerization of isocyanates.

Use according to the previous paragraph, wherein the molar ratio of the compound according to formula (I) and the total amount of all isocyanates is between 5 ppm and 10%.

Use according to one of the two previous paragraphs, wherein X is a free electron pair and in the oligomerization at least one structure is formed selected from the group consisting of isocyanurate, iminooxadiazinedione, uretdione, and particularly preferably at least one isocyanurate structure.

Use according to the previous paragraph, wherein the compound of formula (I) is used in a reaction solution comprising a polar and a non-polar phase.

Use according to one of the previous four paragraphs, wherein X is oxygen and the oligomerization proceeds with formation of a carbodiimide

Process for producing a polyisocyanate composition comprising oligomeric polyisocyanates comprising the steps of a) providing a reaction mixture comprising at least one compound according to the general formula (I) as defined in the first or second paragaph and at least one isocyanate; b) reacting the at least one isocyanate to give an oligomeric polyisocyanate; c) extracting the compound according to formula (I) from the reaction mixture by extraction with a solvent A.

Process according to the previous paragraph, wherein after the extraction step c), at least 90% of the total amount of the compound according to formula (I) present in the reaction mixture at the start of process step c) is dissolved in the solvent A.

Process according to one of the two preceding pargraphs, wherein the molar ratio of the compound according to formula (I) and the total amount of all diisocyanates provided in the reaction mixture in process step a) is between 5 ppm and 10%.

Process according to any of one of the three preceding paragraphs, wherein at least 10% by weight of solvent A is used for the extraction, based on the mass of the reaction mixture.

Process according to any of the four preceding paragraphs, wherein the process is carried out with addition of a solvent B having a miscibility gap with the solvent A per se or in the presence of the oligomeric polyisocyanate composition and (i) the solubility of the compound according to formula (I) in solvent A is higher than in solvent B by at least a factor of 10 and (ii) the solubility of the oligomers formed in process step b) in solvent B is higher than in solvent A by at least a factor of 10.

Oligomeric polyisocyanate composition comprising a molar proportion of phosphorus between 0 and 100 ppm, based on the total weight of the oligomeric polyisocyanate composition.

Oligomeric polyisocyanate composition according to the preceding paragraph, characterized in that said composition comprises aliphatic and/or cycloaliphatic and/or aromatic isocyanates to an extent of at least 90% by weight, based on the total amount of all isocyanates present therein.

1. A compound of the formula (I)
[(R¹SiO_{3/2})ₙ₋₁(R²SiO_{3/2})]ₙ (I)
wherein
n is an even number from 6 to 18,
each radical R¹ is each independently
a branched or unbranched C₁₋₂₀-alkyl radical,
a branched or unbranched C₁₋₂₀-alkenyl radical,
a branched or unbranched C₁₋₂₀-alkynyl radical,
a C₄₋₁₂-cycloalkyl radical,
a C₁₋₂₀-oxoalkyl radical,
a C₆₋₁₈-aryl radical,
an oxoaryl radical,
a hetaryl radical,
a perfluoro-alkyl, -alkenyl, -alkynyl, -alkoxyalkyl- or -aryl radical,
or
an arylalkyl radical, and
R² is a structural element of the formula (II) 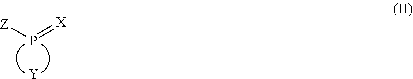
wherein
Z is selected from the group consisting of (CR³₂)ₘ, ortho-, meta- or para-C₆R³₄,
C₆R³₄CR³₂, (CR³₂)₂—Si(R³₂)—(CR³₂)ₒ, C₄₋₁₂-cycloalkylene,
and wherein m is a natural number from 1 to 15,
o is a natural number from 1 to 4,
R³ are the same or different substituents selected from the group consisting of H, methyl and ethyl,
Y is C₄₋₂₀-alkylene or polycyclic C₆₋₃₀-alkylene and
X is a free electron pair or an O atom.

2. The compound according to claim 1, wherein
m is an even number from 6 to 12,
each radical R¹ is each independently
a branched or unbranched C₁₋₁₀-alkyl radical,
a branched or unbranched C₁₋₁₀-alkenyl,
a branched or unbranched C₁₋₁₀-alkynyl,
a C₄₋₈-cycloalkyl,
a C₆₋₁₂-aryl,
Z is selected from the group consisting of (CR³₂)ₘ, ortho-, meta- or para-C₆R³₄, C₆R³₄CR³₂, C₄₋₁₂-cycloalkylene,
m is a natural number from 1 to 10,
R³ is H,
X is a free electron pair or an O atom and
Y is C₄₋₁₆-alkylene, or
Y is a bicyclic C₆₋₁₀-alkylene.

3. The compound according to claim 1, wherein
n=8,
R¹ is C₄-alkyl,
Z is (CR³₂)ₘ where m=3 or m=4 and R³=hydrogen,
Y is C₄-alkylene or C₈-bicycloalkylene, and
X is a free electron pair or an O atom.

4. In a process for the oligomerization of isocyanates, the improvement comprising including the compound according to claim 1.

5. The process according to claim 4, wherein the molar ratio of the compound according to formula (I) and the total amount of all isocyanates is between 5 ppm and 10%.

6. The process according to claim 4, wherein X is a free electron pair and in the oligomerization at least one structure is formed selected from the group consisting of isocyanurate, iminooxadiazinedione, uretdione, and particularly preferably at least one isocyanurate structure.

7. The process according to claim 6, wherein the compound of formula (I) is included in a reaction solution comprising a polar and a non-polar phase.

8. The process according to claim 4, wherein X is oxygen and the oligomerization proceeds with formation of a carbodiimide.

9. A process for producing a polyisocyanate composition comprising oligomeric polyisocyanates, the process comprising the steps of
a) providing a reaction mixture comprising at least one compound according to the formula (I) as defined in claim 1 and at least one isocyanate;
b) reacting the at least one isocyanate to give an oligomeric polyisocyanate;
c) extracting the compound according to formula (I) from the reaction mixture by extraction with a solvent A.

10. The process according to claim 9, wherein after the extraction step c), at least 90% of the total amount of the compound according to formula (I) present in the reaction mixture at the start of process step c) is dissolved in the solvent A.

11. The process according to claim 9, wherein the molar ratio of the compound according to formula (I) and the total amount of all diisocyanates provided in the reaction mixture in process step a) is between 5 ppm and 10%.

12. The process according to any of claim 9, wherein at least 10% by weight of solvent A is used for the extraction, based on the mass of the reaction mixture.

13. The process according to claim 9, wherein the process is carried out with addition of a solvent B having a miscibility gap with the solvent A per se or in the presence of the oligomeric polyisocyanate composition and
(i) the solubility of the compound according to formula (I) in solvent A is higher than in solvent B by at least a factor of 10 and
(ii) the solubility of the oligomers formed in process step b) in solvent B is higher than in solvent A by at least a factor of 10.

14. An oligomeric polyisocyanate composition comprising a molar proportion of phosphorus between 0 and 100 ppm, based on the total weight of the oligomeric polyisocyanate composition.

15. The oligomeric polyisocyanate composition according to claim 14, wherein said composition comprises aliphatic and/or cycloaliphatic and/or aromatic isocyanates to an extent of at least 90% by weight, based on the total amount of all isocyanates present therein.
